(19) United States
(12) Patent Application Publication
(10) Pub. No.: US 2024/0394650 A1
(43) Pub. Date: Nov. 28, 2024

(54) Automobile Telephone Processing System For a Vehicle

(71) Applicants: Scott C. Harris, San Diego, CA (US); Benjamin J. Kwitek, Colorado Springs, CO (US)

(72) Inventors: Scott C. Harris, San Diego, CA (US); Benjamin J. Kwitek, Colorado Springs, CO (US)

(21) Appl. No.: 18/322,138

(22) Filed: May 23, 2023

(51) Int. Cl. G06Q 10/0836; G06Q 30/0601

(52) U.S. Cl. CPC G06Q 10/0836; G06Q 30/0633

(57) ABSTRACT

Deliveries are made to a vehicle by setting a current or future location of the vehicle as the location for the delivery. A smartphone is connected to the vehicle to have access to the vehicle systems, and then the access to those systems is piggy-backed to allow the deliverer to open the vehicle to make the delivery.

### BACKGROUND

Technology has transformed the way we go through our lives. As hardware for the technology improves, consumers rush to improve their own personal devices, such as cell phones and tablets.

Automobiles are installed with many different kinds of technology. New technology in automobiles can be a powerful reason why consumers want to buy new cars. New cars often come with the latest technology, from monitoring systems, to automatic driving systems, entertainment options and others.

Unlike a smartphone with 12-36 month replacement cycles, a typical consumer may wait much longer between buying new cars. Some consumers buy new cars at the end of a lease. Others wait until the car starts to age, is out of warranty or experiences mechanical or maintenance issues.

People may buy a new car to get the new technology that is in that new car.

Automobiles often have technology such as Airplay or other similar apps that allow user to use the technology from their smartphone in the car, for example to use the mapping app from their smartphone to be displayed on the screen of their car. This is typically because the screen in the car is larger or better placed than the screen on the telephone and the speakers in the car are better set to produce audio to the driver. Furthermore, the microphone installed in the car is more convenient to the driver's position than the microphone on the smartphone.

### SUMMARY

The inventors recognized that current systems in vehicles have limitations, and specifically that it would be useful to be able to use the user's personal electronic devices in new ways in a vehicle.

The present application describes using the technology in the smartphone to control operations in a vehicle.

In an embodiment, the smartphone assesses the location of the vehicle and uses that location as the location to receive delivery from a phone-based delivery app.

### BRIEF DESCRIPTION OF THE DRAWINGS

These and other aspects will now be described with reference to the accompanying drawings wherein:

The Drawings show aspects of the invention, and specifically,

FIG. 1 shows a block diagram of a vehicle and a smartphone wirelessly communicating with the vehicle;

FIG. 2 shows a flowchart of phone operation in the vehicle;

FIG. 3 shows a flowchart of operations including delivering to a vehicle.

### DETAILED DESCRIPTION

Any of the embodiments described herein may be used together, or separate parts thereof can be used as separate embodiments.

The present application describes using technology from a personal device of a user, e.g, a smartphone, as part of the operation of an automobile, in a completely new way. The intent of certain embodiments is that when the user upgrades their personal technology, be that technology a smartphone, tablet, or other computer, by doing so they are also upgrading the capabilities of their vehicle.

The present invention describes a computer system that is in the vehicle, and interfaces with the personal device of the user, to take advantage of operations that can be carried out on the personal device of the user.

By using the user's personal device, the apps, user interfaces, and other parts of the user's personal device can be used by interfacing with the vehicle systems.

For purposes of this application, embodiments refer to a portable smartphone as being the personal technology, and refer to an automobile as being the vehicle. However it should be understood that other personal technologies and other vehicle types are intended to be encompassed within this specification.

Car Play and Android Auto are programs that mirrored features of the smart smartphone onto the car's dashboard. Once the smartphone has been paired with the computer unit in the car, supported apps from the smartphone can be mirrored on to the screen of the automobile and played to speakers on the vehicle.

The inventor recognizes that as technology improves, the smartphone may actually have a better display than the car. The smartphone may have better speakers than the car. According to the present system, and many of the teachings provided herein, every time you replace your smartphone, you are upgrading your car.

An embodiment describes these systems being part of the built-in system of the vehicle. However, these can alternatively be retrofits or plug-ins to a vehicle.

An embodiment describes using the smartphone as an additional displaying computer on the car, so that it becomes the opposite of apps such as CarPlay. Instead of the car display showing displaying items on the smartphone screen as in CarPlay, this system, once paired, displays items received from technology of the vehicle, and the surroundings of the vehicle, on the smartphone display, so that the smartphone becomes part of control of the vehicle.

In embodiments, this can be used to control vehicle systems.

Another embodiment describes displaying information from car cameras on the smartphone screen, wirelessly for example by Wi-Fi or Bluetooth.

Another embodiment describes using the microphone on the smartphone to enter data into the car.

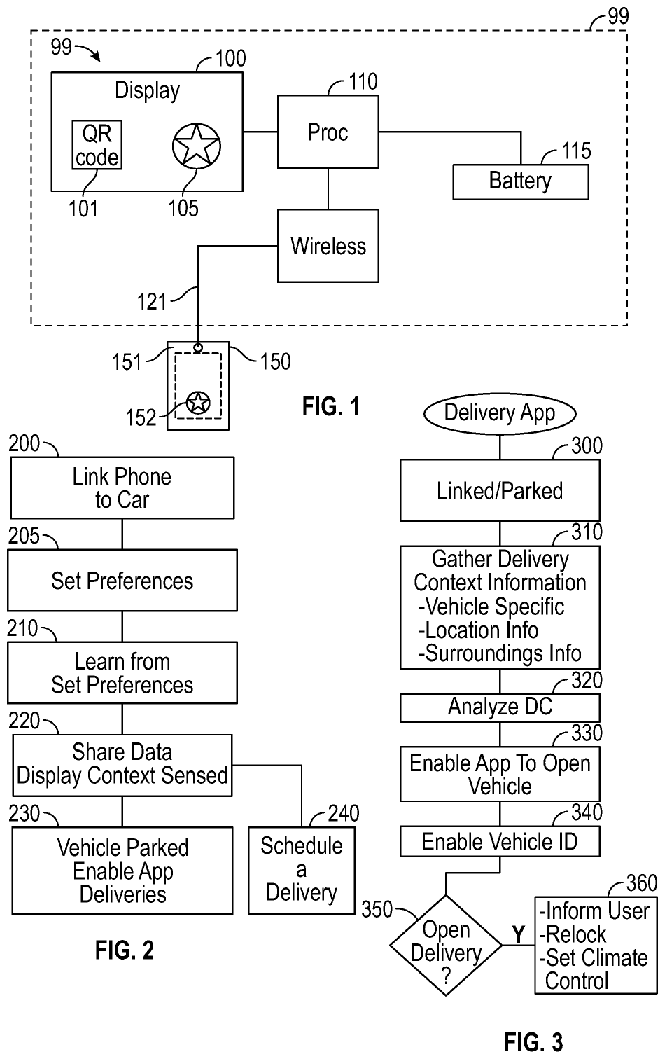

An embodiment is shown in FIG. 1. Inside the automobile 99 is a display 100, and controls 105 for the display. The controls can be of any type. All of the information for the display and the controls is driven by and received by processor 110, which is the automobile processor powered by the automobile battery 115. The processor 110 also communicates with a wireless device 120, which communicates via a wireless format, e.g., wifi, Bluetooth or any other wireless format, with the user portable device, here shown as a smartphone 150.

In operation, the display 100 begins by displaying a QR code 101, which is imaged by the camera 151 on the smartphone 150. The QR code provides a special link, which provides a private wireless access channel to the wireless card 120, thus pairing the smartphone 150 with the car 99. At this point, smartphone 150 and the car are linked, over the link 121 which is a private wireless link which enables two-way communication of information between the smartphone 150 and the car systems.

Once paired, the user interface 105 is displayed on either or both of the display 100 of the car or on a display 152 of the smartphone 150.

The processor 110 operates to allow certain functions of the vehicle to be controlled by the controls on a linked smartphone.

The user interface operates according to the flowchart of FIG. 2. At 200, the smartphone is linked to the car, using the techniques described above.

At 205, the user is allowed to set preferences. These preferences can include a user setting which data they want displayed or controlled by the smartphone or on the car or both. The preferences can be manually set, or can be learned by the system at 210. One way in which the learning can be carried out at 210 is that when a user requests a specific operation to be used with smartphone involvement, during specific operations of the vehicle, that is learned and maintained as a future preference.

In one embodiment, the controls 105 can be displayed on the screen 152 along with the display of the specific current operation. The user can use these controls to select a specific operation that they want to carry out. The displays that are carried out are context sensitive, that is based on a specific thing that is happening in the vehicle.

One context sensitive operation may be that whenever the car is backing up, on most relevant camera data is shared to the smartphone which is automatically displayed on the smartphone. The user can cancel this display if they prefer to have a different display on the smartphone. However, if the user continues to use the popped up display, then this is learned at 210 as part of the context of “car backing up” and set as a preference. If the user cancels the display, this is also used as a preference, of “I don't want the camera to show when the car is backing up”.

After setting preferences, a share data operation is carried out at 220. This share data operation operates to send specified information from the car to be displayed on the smartphone, and specified information from the smartphone to be displayed on the car. Share data operation operates according to the preferences

Also the user interface on the smartphone can be used to control operations on the car. For example, by tapping on the smartphone, controls 105 for the car can be initiated. The controls 105 allow the user to cycle through various menu of controls on the vehicle. The menus can use the smartphone to control air-conditioning, speed, cruise control, and all other operations, all from the smartphone. The user can use voice controls entered into the smartphone to control these systems and operations.

When the user carries out a specific control from the smartphone, that is learned, and postulated as being the specific control to be used by the vehicle, as a function of the context of the vehicle. When the vehicle for example is cruising, with cruise control on, the user may ask to control the speed of the vehicle. The context of the vehicle this can be learned as context, for example when the vehicle is cruising with cruise control, bring up the ability to adjust the speed.

Another context sensitive operation is when the vehicle is parked, enable setting the parked location as a delivery location for delivery app. This is described herein.

The share data at 220 determines what data should be sent from and sent to the smartphone. Learned actions include sending data for anything that has been previously learned by the smartphone in its operation. This can be a learned action and can be set as an initial step. Important views from the camera can be set as defaults to be sent to the smartphone, unless cancelled, with the cancellation being learned. These important views can be selected, or can be chosen based on operations. For example, as the vehicle is turning, the side cameras are automatically sent to the smartphone so that the user can see the side camera views. Similarly, when the car is backing up, rear camera views can be sent to the smartphone. When the vehicle is normally operating, the user interface views such as 105 are sent to the smartphone, and controls entered on the smartphone are sent to the smartphone.

At 230, the context is determined to be that the vehicle is parked, and a special operation is enabled when the vehicle is parked to enable app based deliveries. IN this way, a smartphone is matched with the car, has its car location set as the location for delivery. This adds in, therefore, an option to certain apps to allow current location of automobile to be the location for delivery using that app.

FIG. 3 shows an embodiment, where a food delivery app such as Uber eats or Instacart is used to deliver food to the car using the system of the present application.

The ability to use the smartphone along with the delivery app smartphone begins at 300, where the file is linked to the vehicle at 200, and the vehicle context is determined to be parked. This unlocks the ability in certain delivery apps to allow delivery to the vehicle.

At 310, the car delivery context information is gathered. The delivery context information includes all of the information that will be necessary for an app-based delivery to be made. This will include information that unambiguously identifies the car to the delivery service. This can include vehicle specific information, including the color make model and license plate. This can also include location information, obtained from the smartphone, as well as from the vehicle. The location information can be GPS fixes obtain from the smartphone and from the vehicle. In some situations, such as in an above ground parking lot work in a parking space, this GPS fix can be very specific. In other locations, however, such as in a multilevel or underground parking garage, the GPS information may not be sufficient to enable unambiguous delivery. The context information can also include surroundings information which can include information from the camera providing views of all the different areas that can be viewed from the camera. In this way, the entire surrounding area of the vehicle can be viewed, Information about the car location is gathered, and sent to the app, including the license, color, make model, GPS location from the smartphone and from the vehicle, as well as photos from the camera about the surroundings of the car. The location of the vehicle can be determined from the smartphone during times when the smartphone is actually in proximity of the vehicle, or from the vehicle itself using the location determination spot in the vehicle.

This recognizes that the vehicle location to which the delivery is to be made may be in a parking lot, or in a garage, or otherwise in a location where additional information may be useful in order to find the vehicle. Accordingly, all of these locations all of these contextual items may be used to pinpoint the location of the. vehicle.

At 320, the delivery context information is analyzed using an AI assistant to determine if it has sufficient information to unambiguously indicate the location of the vehicle. The analysis at 320 determine if the vehicle is in a parking area, such as a parking garage or a parking lot. If the vehicle is simply parked in a street space, then its location can be less ambiguously determined. However, if the vehicle is in a lot, then additional information may be necessary. If the vehicle is parked in a multiple level lot, the system determines based on the context and specifically surroundings information, whether it can analyze the proper level of the parking garage where the vehicle is located. Ideally, the system would be able to find the level and the space number from the camera information. Many parking garages have space numbers and levels that are identified so that the users can find their way back to the car. This can be found from the camera information.

In another embodiment, the system once parking, may review the previous minutes of footage, such as 3 to 5 minutes of footage, in order to find information from the video that show parking lot signs, to use that as part of the surroundings information.

In an embodiment, the app may return this information to the user, for example it may say, “I think you're in a parking garage level V space 632, is that correct?” All of this can be obtained from context, or if the context is insufficient, then the system can prompt the user to manually input the information.

When the user links the smartphone to the vehicle, the binding also provides the smartphone with the ability to interact with certain parts of the vehicle. In one embodiment, at 330, this allows the deliverer access to open openable parts of the vehicle: the openable parts include any part of the vehicle that can be opened: doors or trunk or hatchback or tailgate of the vehicle.

Another aspect can allow the window to be opened, so that the deliverer can set the delivery into the inside passenger compartment of the vehicle. The user can then set the desired delivery location where they want items to be delivered into the vehicle.

Take for example a Tesla. The user may set the location where they want the items to be delivered, to be the hatchback of the Tesla. Then, the user sets, on the smartphone, permission to allow the delivery person to open the hatchback of the Tesla when the user is not there.

Since the smartphone has been linked to the vehicle, this enables the delivery person to piggyback off of this linkage to open a door or window of the vehicle to make the delivery.

Another aspect which is based on the location is vehicle ID at 340. If the delivery person is having trouble finding the vehicle, the linkage can enable the vehicle person to piggyback on the linkage to cause the vehicle to identify itself. This can for example cause lights or sound to be emitted by the vehicle. If the delivery is having difficulty finding the vehicle, then the deliverer can cause the vehicle to turn on its lights or flash its horn at 340.

In any case, once the vehicle is found, delivery is made at 350. The delivery is made by opening the vehicle using the piggybacking off of the linkage on the app. The deliverer opens the vehicle, inserts the item, and recloses the vehicle. This causes an indication that the item has been delivered. The delivery notification at 360 informs the user of the delivery. At the same time, it checks to see if the vehicle is closed and locked, and sets a climate control. The climate control can be set as one of the options of the delivery. If groceries are being delivered, for example, the climate control can be set to maintain the vehicle at no hotter than 80° for example.

In one embodiment, the vehicle may have a special delivery location set in the vehicle, e.g. an insulated box, hot box or cold box, that can be powered from vehicle systems. This can be turned on as part of the climate control at 360.

The user sets where they want items delivered, and then sets the vehicle location as the desired location. As part of this, the user must say that the vehicle will not move locations for a certain amount of time. For example, when a user is in an office, they know that they will not move their vehicle for example until 5 o'clock. This then sets the final time for delivery at the vehicle location as 5 o'clock, requiring that the items be delivered by then.

The app can also provide a QR code that allows the delivery person into the parking garage to get to the car.

The items are then set for delivery, and the delivery person uses the app to open the desired door of the vehicle at 450.

After opening the door, if there is a cold box or temperature box more generally set, then the user uses this to put the items into. At that point, after the delivery has been marked as complete, the app, running on the smartphone, automatically tells the vehicle that the items have been delivered. The delivery of those items causes the active temperature box to either get cold or hot in order to heat or cool the items as needed.

In this way, the user can use their smartphone to order items either to be delivered to their home, or to their car. When the user sets the home as the location, it gets delivered to their front door. However, the user can be at work, and set the car as their location.

The above has described the delivery being a delivery from an app, and contemplates the same day delivery operation, such as Instacart or other same-day deliveries. However, the delivery can be more generally any delivery which is going to be made to a user. In one embodiment, delivery can be an item ordered from an online retailer such as Amazon, to be delivered in the future, and the location of the vehicle set as the location where the future delivery should be made.

Users very often are not home during the time when the packages delivered, causing the package to be left. So-called porch pirates have started to steal packages which are left in front of houses. Sometimes the user is just out at a grocery or some other random location. When this happens, it may be difficult to coordinate with the system where to deliver a package. However, very often a user knows that they will be at work between certain hours, or knows that they will be at a specified appointment between certain hours. When this happens, the user can schedule a delivery to their vehicle at its parked location. As an alternative to the vehicle being parked and enabling the app deliveries at 230, the user can schedule a future delivery to their vehicle at 240. For example, this can be either an act delivery to be made in the future (such as deliver my groceries between 1 PM and 3 PM tomorrow my car will be parked at either a set location or a set location to be determined) as another example, this can be set as a delivery location for delivery made by mail-order such as Amazon. The user may tell Amazon, deliver my package between 1 PM and 3 PM tomorrow, my vehicle will be at a location where it will not move between those hours. The system as used herein can be used to gather delivery context information, and provide that to the vehicle. In the example of a Amazon delivery, the user may add the additional information of where they will be parked or the general location where they will be parked to enable the coordination of the delivery. Once set up, however, the delivery person can piggyback on the linked smartphone to open the vehicle, and enable deliveries into the vehicle.

Another embodiment describes using the smartphone as your decryption or personal decryption device, such as two-party encryption,

Another embodiment describes intelligence on the smartphone carrying out analysis of the results of the cameras, for example to assist with self-driving, or for other purposes.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A vehicle system including a vehicle, comprising:
plural openable parts of the vehicle;
a processor in the vehicle, controlling opening of the openable parts of the vehicle;
the processor controlling linking a user smartphone to the vehicle to create a linked user smartphone,
the user using the linked user smartphone to send an access command to the vehicle from the linked user smartphone to control opening of the openable parts of the vehicle;
the processor determining that the vehicle is parked, and when the vehicle is parked, the linked user smartphone being used to obtain information about a parked location and, to use said information to communicate the information to a delivery application running on the linked user smartphone,
the delivery application using a delivery person to deliver items, the delivery person having a portable device associated with the delivery person;
the delivery person initiating a command to open the vehicle using the portable device associated with the delivery person,
the command sent to the linked user smartphone,
and the linked user smartphone controlling, responsive to receiving the command, sending the access command to open the openable part of the vehicle, to receive a delivery into the vehicle while the vehicle is parked.

2. The system as in claim 1, wherein the information about the parked location of the vehicle includes a location of the vehicle, and image information showing current surroundings of the vehicle and also includes video taken prior to parking showing previous footage of image information around the vehicle that were obtained by the vehicle at times prior to the vehicle parking in the parked location the video taken prior to parking including parking lot signs found while the vehicle was parking.

3. The system as in claim 1, wherein the information about the parked location of the vehicle includes a location of the vehicle, and the parked location is obtained from image information showing current surroundings of the vehicle from multiple different views from multiple different cameras on the vehicle.

4. The system as in claim 1, wherein the information about the parked location of the vehicle includes image information showing current surroundings of the vehicle obtained from a camera in the vehicle that images the vehicle's current surrounding, and where a processor associated with the delivery application examines the image information to find a parking space number in the image information.

5. The system as in claim 4, wherein the processor associated with the delivery application examines the image information to find a number of a level of a multiple level parking garage in the image information.

6. The system as in claim 1, wherein the delivery application receives the delivery person sending a request from the portable device associated with the delivery person to cause the vehicle to cause lights or sound to be emitted by the vehicle, and causes the linked user smartphone to cause the vehicle to cause lights or sound to be emitted by the vehicle responsive to the request.

7. The system as in claim 1, wherein the processor turns on a climate control after the delivery has been made.

8. A delivery system for delivering to a vehicle, comprising: a vehicle, having a processor, and having a wireless communication capability; the processor operating using the wireless communication capability to link a user smartphone with the vehicle to create a linked user smartphone, and to provide an ability to open at least one part of the vehicle by sending an access command from the linked user smartphone once the linked user smartphone is linked, the access to systems including providing the linked user smartphone with a capability to open at least one part of the vehicle by sending the access command;
a computer, enabling placing an order for items to be delivered,
where the order for the items to be delivered uses a linking between the linked user smartphone and the vehicle to allow a deliverer to open the at least one part of the vehicle, by the deliverer requesting to open the at least one part of the vehicle using a portable device associated with the deliverer,
the deliverer requesting sent from the portable device associated with the deliverer to the linked user smartphone,
and the linked user smartphone sending the access command to open of the at least one part of the vehicle responsive to the deliverer requesting, to deliver the items to an internal compartment of the vehicle.

9. The system as in claim 8, wherein the computer provides information to the deliverer about a future location where the vehicle will be at a time subsequent to when the order is placed, obtained when the order is placed, where the time subsequent to when the order is placed is a different location than where the vehicle is when the order is placed and where the information provides the information about the future location and a start time for the vehicle to be at the future location and an end time for the vehicle to be at the future location.

10. (canceled)

11. The system as in claim 8, wherein a location information about the vehicle is found from surroundings information about the vehicle that is obtained from multiple different cameras showing current surroundings of the vehicle from multiple different views from multiple different cameras on the vehicle.

12. The system as in claim 8, further comprising the deliverer sending a request to the linked user smartphone to cause the vehicle to identify itself, and the portable device associated with the deliverer sending a message to the linked user smartphone to cause the vehicle to cause lights or sound to be emitted by the vehicle.

13. The system as in claim 8, wherein information about a parked location of the vehicle is used, including a location of the vehicle, and image information showing current surroundings of the vehicle and also includes video taken prior to parking showing previous footage of image information around the vehicle that were obtained by the vehicle at times prior to the vehicle parking in the parked location and include parking lot signs found while the vehicle was parking.

14. A method of delivering to a vehicle, comprising:
establishing a link between a user's portable device and a processor in the vehicle, which enables the user's portable device to obtain information from the vehicle and to control certain functions in the vehicle including opening the vehicle, and to create a linked user portable device;
sending an access command from the user's portable device to open the vehicle;
from the user's portable device, placing an order with a service that delivers to a location, the placing an order comprising setting the vehicle as being the location to which a delivery should be delivered;
a deliverer controlling opening the vehicle to make the delivery by using a portable device associated with a delivery person to send a request to the linked user portable device and using the linked user portable device to send the access command to control opening of the vehicle, and to deliver the delivery to an inside compartment of the vehicle.

15. The method as in claim 14, further comprising, the delivery person sending a request from the portable device associated with the delivery person to cause the vehicle to cause lights or sound to be emitted by the vehicle, and the linked user device causing the vehicle to cause lights or sound to be emitted by the vehicle responsive to the request.

16. The method as in claim 14, further comprising sending delivery context information from the vehicle to the deliverer, the delivery context information including specific information about a location of the vehicle.

17. The method as in claim 16, wherein the delivery context information includes image information obtained from cameras of the vehicle showing current surroundings of the vehicle and also includes video taken prior to parking showing previous footage of image information around the vehicle that were obtained by the vehicle at times prior to the vehicle parking in a parked location and include parking lot signs found while the vehicle was parking.

18. The method as in claim 14, further comprising the delivery person sending a request to the linked user device to cause the vehicle to identify itself, and the portable device associated with the delivery person sending a message to the linked user device to cause the vehicle to cause lights or sound to be emitted by the vehicle.

19. The method as in claim 14, wherein information about a parked location of the vehicle is sent to the deliverer, including image information showing current surroundings of the vehicle and also includes video taken prior to parking showing previous footage of image information around the vehicle that were obtained by the vehicle at times prior to the vehicle parking in the parked location and include parking lot signs found while the vehicle was parking.

20. The method as in claim 14, wherein the delivery is ordered to a future location where the vehicle will be at a time subsequent to when the order is placed, obtained when the order is placed, where the time subsequent to when the order is placed is a different location than where the vehicle is when the order is placed and where the information provides the information about the future location and a start time for the vehicle to be at the future location and an end time for the vehicle to be at the future location.
